(19) United States
(12) Patent Application Publication
(10) Pub. No.: US 2011/0243075 A1
(43) Pub. Date: Oct. 6, 2011

(54) METHOD AND APPARATUS FOR ACCESS PROCEDURE IN A WIRELESS COMMUNICATION SYSTEM

(75) Inventors: Tao Luo, San Diego, CA (US); Yongbin Wei, San Diego, CA (US); Durga Prasad Malladi, San Diego, CA (US)

(73) Assignee: QUALCOMM Incorporated, San Diego, CA (US)

(21) Appl. No.: 12/816,256

(22) Filed: Jun. 15, 2010

Related U.S. Application Data
(60) Provisional application No. 61/187,595, filed on Jun. 16, 2009.

(51) Int. Cl. H04W 74/08

(52) U.S. Cl. 370/329

(57) ABSTRACT

An enhanced random access procedure for current and future versions of user equipment communicating with base stations. A random access preamble is transmitted, wherein the random access preamble comprises release version information of a user equipment. A payload portion of a random access response is derived, and a contention resolution message is received.

### CROSS-REFERENCE

This application claims the benefit of U.S. Provisional Application Ser. No. 61/187,595, filed Jun. 16, 2009, entitled “IMPROVED ACCESS PROCEDURE,” and assigned to the assignee hereof and the entirety of which is incorporated herein by reference.

### BACKGROUND

I. Field

The present disclosure pertains to wireless communication systems, and in particular, to improved random access procedure for current and future versions of user equipment communicating with base stations.

Wireless communication systems are widely deployed to provide various communication content such as for example voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

Generally, a wireless multiple-access communication system can concurrently support communication for multiple wireless terminals. Each terminal communicates with one or more base stations via transmissions on forward and reverse links. The forward link (or downlink) refers to the communication link from base stations to terminals, and the reverse link (or uplink) refers to the communication link from terminals to base stations. This communication link may be established via a single-in-single-out, multiple-in-signal-out or a multiple-in-multiple-out (MIMO) system.

A wireless system base station can communicate with several user equipment (UE). Each UE may comprise different release versions (such as Rel-8, Rel-9, Rel-10, or beyond) and capabilities (such as MIMO or SIMO). Each release version is typically associated with a particular specification comprising a set of requirements. A UE can be identified as being a Rel-8, Rel-9, Rel-10 or any suitable future release, user equipment. Each release generally has more capabilities than a previous version. Thus, newer release UE(s) have more capabilities than older counterparts. It may be desirable to provide enhanced access procedure for current and future release versions of user equipment.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In accordance with one or more aspects and corresponding disclosure thereof, various aspects are described in connection with providing an access sequence for a wireless communication system.

In one aspect, an apparatus is provided for transmitting a random access preamble, wherein the random access preamble comprises release version information of user equipment, deriving a payload portion of a random access response, and receiving a contention resolution message.

In another aspect, at least one processor is provided for transmitting a random access preamble, wherein the random access preamble comprises release version information of user equipment, deriving a payload portion of a random access response, and receiving a contention resolution message.

In an additional aspect, a computer program product is provided to transmit a random access preamble, wherein the random access preamble comprises release version information of user equipment, derive a payload portion of a random access response, and receive a contention resolution message.

In another aspect, a method is provided for transmitting a random access preamble, wherein the random access preamble comprises release version information of a user equipment, deriving a payload portion of a random access response, and receiving a contention resolution message.

In one aspect, an apparatus is provided for receiving a random access preamble, determining a release version of user equipment transmitting the random access preamble, selecting one or more Random Access Channel (RACH) sequences from a set of RACH sequences based on the release version of a user equipment transmitting the random access preamble to generate a random access response, and transmitting the random access response using a first scheme.

In another aspect, at least one processor is provided for receiving a random access preamble, determining a release version of user equipment transmitting the random access preamble, selecting one or more Random Access Channel (RACH) sequences from a set of RACH sequences based on the release version of a user equipment transmitting the random access preamble to generate a random access response, and transmitting the random access response using a first scheme.

In an additional aspect, a computer program product is provided to receive a random access preamble, determine a release version of user equipment transmitting the random access preamble, select one or more Random Access Channel (RACH) sequences from a set of RACH sequences based on the release version of a user equipment transmitting the random access preamble to generate a random access response, and transmit the random access response using a first scheme.

In another aspect, a method is provided for receiving a random access preamble, determining a release version of user equipment transmitting the random access preamble, selecting one or more Random Access Channel (RACH) sequences from a set of RACH sequences based on the release version of a user equipment transmitting the random access preamble to generate a random access response, and transmitting the random access response using a first scheme.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a multiple access wireless communication system according to one embodiment;

FIG. 2 illustrates a block diagram of a communication system;

FIG. 3 illustrates an example system that exchanges messages in connection with a random access procedure in a wireless communication environment;

FIG. 4 illustrate an example methodology that facilitates base station for using the enhanced access.

FIG. 5 illustrate an example methodology that facilitates user equipment for using the enhanced access.

FIG. 6 illustrates an example methodology that facilitates allowing different releases of UEs to use different subsets of Random Access Channel (RACH) sequences for delivering a random access preamble (message 1) in a wireless communication environment;

FIG. 7 illustrates an example methodology that facilitates delivering UE capability information to a base station in a wireless communication environment;

FIG. 8 illustrates an example methodology that facilitates delivering a temporary radio network temporary identifier (RNTI) and/or a grant to a UE without using a random access response (message 2) in a wireless communication environment;

FIG. 9 illustrates an example methodology that facilitates decoding a data channel that carried a random access response (message 2) without decoding control channels in a wireless communication environment;

FIG. 10 illustrates an example methodology that facilitates sending a scheduled transmission (message 3) without decoding downlink acknowledging channels in a wireless communication environment;

FIG. 11 illustrates an example methodology that facilitates decoding a contention resolution message (message 4) without decoding control channels in a wireless communication environment;

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station can be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The word “exemplary” is used herein to mean serving as an example, instance, or illustration. Any aspect or design described herein as “exemplary” is not necessarily to be construed as preferred or advantageous over other aspects or designs.

Additionally, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

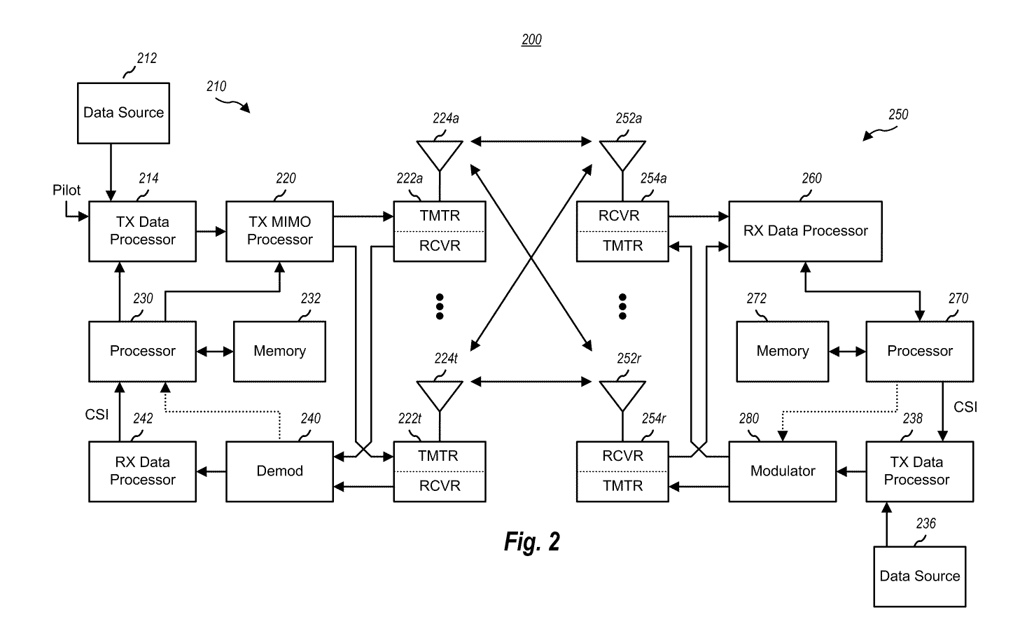

FIG. 2 is a block diagram of an embodiment of a transmitter system 210 (also known as the access point, base station and eNodeB) and a receiver system 250 (also known as access terminal and user equipment) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

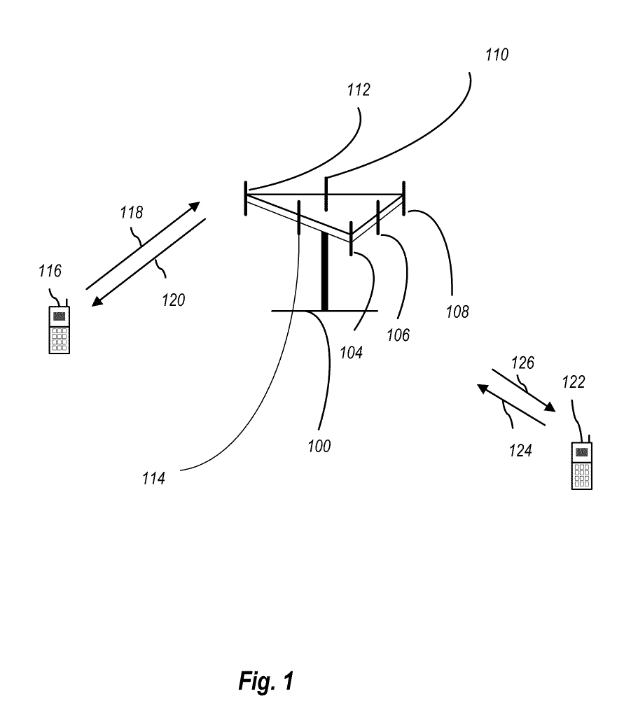

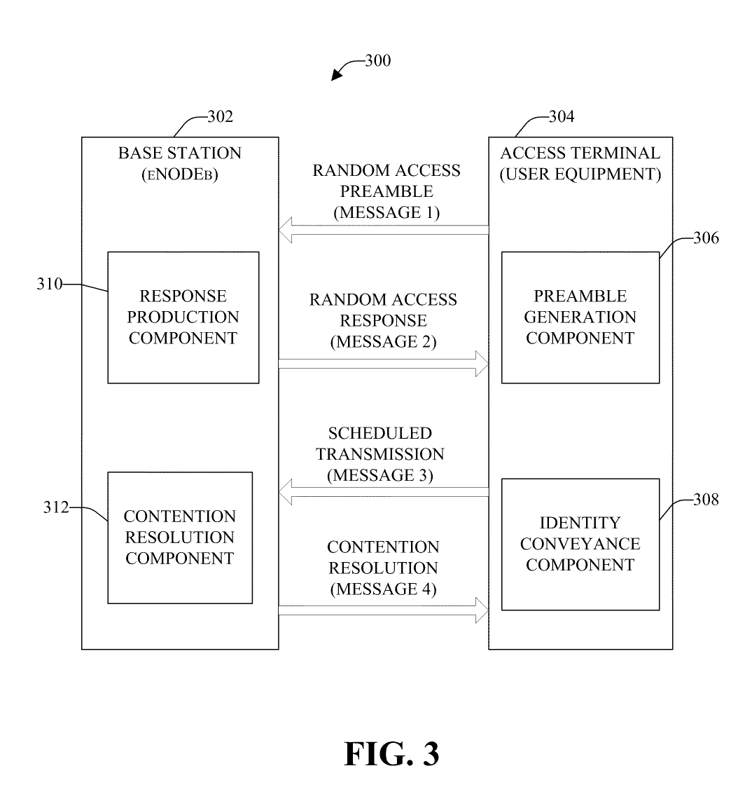

FIG. 3A illustrates a multicarrier system 300 with symmetric configuration, which includes downlink carriers (DL CL1 and DL CL2) 306 and 310 and uplink carriers (UL CL1 and UL CL2) 308 and 312. These carriers are used to exchange information between base station 302 and access terminal 304. The base station 302 and access terminal 304 correspond to the base station 100 and access terminal 116 shown in FIG. 1. The system is symmetric in the that the number of downlink carriers 306 and 310 are equal to the number of uplink carriers 308 and 312 and that downlink carrier 306 is paired with uplink carrier 308 and downlink carrier 310 is paired with uplink carrier 312. Although only two downlink and two uplink carriers are shown, the system 300 may be configured to include any suitable number of downlink and uplink carriers.

FIG. 3 illustrates an example system 300 that exchanges messages in connection with a random access procedure between base station 302 and user equipment 304 operating in a wireless communication environment. The base station 302 and user equipment 304 correspond to the base station 100 and access terminal 116 shown in FIG. 1. Base station 302 can transmit and/or receive information, signals, data, instructions, commands, bits, symbols, and the like. Base station 302 can communicate with a User Equipment (UE) 304 via forward link and/or reverse link. UE 304 can transmit and/or receive information, signals, data, instructions, commands, bits, symbols, and the like. Moreover, although not shown, it is contemplated that any suitable number of base stations similar to base station 302 can be included in system 300 and/or any number of UEs similar to UE 304 can be included in system 300.

The UE 304 can further include a preamble generation component 306 and an identity conveyance component 308, and base station 302 can further include a response production component 310 and a contention resolution component 312. UE 304 and base station 302 can exchange messages as part of a random access procedure prior to UE 304 entering a system. For example, in Long Term Evolution (LTE) Release 8 (Rel-8), UE 304 and base station 302 can exchange four messages; however, the claimed subject matter is not so limited as described herein. Message 1 can be a random access preamble yielded by preamble generation component 306 sent by UE 304 to base station 302. By way of illustration, the random access preamble can be sent via a Physical Random Access Channel (PRACH). The UE monitors for Message 2 which can be a random access response yielded by response production component 310. The random access response can be transmitted by base station 302 to UE 304. Conventionally, the random access response can provide timing alignment information, an initial uplink grant, assignment of a temporary radio network temporary identifier (RNTI), and so forth. Message 3 can be a scheduled transmission generated by identity conveyance component 308; the scheduled transmission can convey an identity associated with UE 304 to base station 302. Conventionally, the identity is the MAC ID (e.g. UE's identification number). However, if there is no MAC ID, then a random id (e.g., 48 bit) is conveyed to the UE 304. Further, message 4 can be a contention resolution message generated by contention resolution component 312 sent by base station 302 to UE 304. The message 4, as part of the payload, provides the UE 304 identification so that the UE 304 can determine that the message 4 is targeted to itself.

Traditional approaches utilized for the random access procedure can result in a number of deficiencies. Conventionally, the random access response (message 2) yielded by response production component 310 and the contention resolution message (message 4) generated by contention resolution component 312 can be transferred via a downlink data channel (e.g., Downlink Shared Channel (DL-SCH), . . . ). To enable UE 304 to decode the downlink data channel which carries the random access response and/or the contention resolution message, typically UE 304 needs to decode downlink control channel(s) (e.g., Physical Control Format Indicator Channel (PCFICH) and Physical Downlink Control Channel (PDCCH), . . . ). Moreover, when there are difference power classes of base stations (e.g., a set of base stations including base station 302 and differing base station(s) (not shown) can include macro cell base station(s), micro cell base station(s), femto cell base station(s), pico cell base station(s), etc., . . . ) coexisting or there is restricted association, UE 304 can see strong interference in downlink or cause strong interference to other base station(s). Further, information conventionally carried by the random access preamble (message 1) and the random access response (message 2), more particularly the payload for message 2, can be implicitly delivered rather than using a Physical Random Access Channel (PRACH) preamble or a message 2 Medium Access Control (MAC) payload. Additionally, the scheduled transmission (message 3) commonly requires UE 304 to decode a Physical Hybrid Automatic Repeat Request (HARD) Acknowledgment/Negative Acknowledgment (ACK/NAK) Indicator Channel (PHICH) to confirm successful reception at base station 302. Moreover, the contention resolution message (message 4) typically requires UE 304 to decode a control channel before decoding a data channel carrying such contention resolution message. Accordingly, system 300 as described herein can leverage a simple and robust access procedure for UE 304 to access a system while mitigating one or more of the aforementioned deficiencies commonly encountered in connection with conventional techniques.

According to an example, system 300 can allow different releases of UEs (e.g., UE 304, disparate UE(s) (not shown), . . . ) to use different sets of Random Access Channel (RACH) sequences for delivering message 1. Thus, depending upon whether UE 304 is a Rel-8 UE or a Release 9 (Rel-9), Release 10 (Rel-10), or beyond UE, preamble generation component 306 can employ different subsets of RACH sequences. For Rel-9 UE or beyond, the base station 302 can apply an enhanced procedure, while for the Rel-8 UE, the base station can apply the conventional RACH procedure. The enhance procedure provides that the base station reserves a plurality of RACH sequences (for example 64) such that only Rel-9 or beyond can use those sequences. The base station, after decoding message 1, can determine the capabilities of UE and the version of the UE (e.g. Rel-8, Rel-9, Rel-10 or beyond). After determining the capabilities and version of the UE, base station can select a RACH sequences from the plurality of RACH sequences to match with version or the capability of the UE. The base station can convey the RACH sequence and its usage through system information block. The base station may use PBCH payload or through physical signal such as PSS/SSS/PRS/RS.

Further, for example, system 300 can support delivering information concerning the subsets of RACH sequences utilized for different releases of UEs to the different releases of UEs (e.g., including UE 304, . . . ). The base station 304 can signal an indication (e.g., a flag) to indicate whether there exists sets of RACH sequence reserved for Rel-9 or beyond UEs. Such flag can be transmitted to UE 304 using SIB, PBCH, PSS, SSS, PRS, RS or any combination signals or channels. The UE 304 may choose not to use the RACH sequences by indicating that it still uses Rel-8 RACH procedure. This determination is made by UE's interference management system and based on location of the UE in comparison to the base station and amount of interference observed.

By way of another example, system 300 can deliver a temporary RNTI value to UE 304 without base station 302 using the random access response (message 2) yielded by response production component 302. Among other items, the payload of message 2 comprises a temp-RNTI value and uplink grant used for message 3. Once the base station 302 detects message 1, the base station 302 can choose not sending temp-RNTI and uplink grant to UEs through message 2. Instead, the base station can provide temp-RNTI value and/or uplink grant using RACH sequence. The UE 304 can derive message 2 payload information using preamble of one or more of the RACH sequence, random access-RNTI, Cell ID, sub-frame number, system frame number and Tx antenna information or any other information UE has acquired through downlink channels. This information is already known by UE using SIB, PBCH, PSS, SSS, PRS, RS or any combination signals or channels. Even though message 2 is transmitted, the does not decode the message 2. Thus, UE can still get this information even when there is strong interference on the control channel used to transmit message 2.

In accordance with another example, base station 302 can send the random access response yielded by response production component 310 to UE 304. UE 304 can decode a data channel carrying the random access response without decoding control channels in order to retrieve the payload information (e.g., temp-RNTI and uplink grant). The UE derives resource/MCS or other information requiring for decoding Physical Downlink Shared Channel (PDSCH) through those mapping functions without decoding control channels. If the resource mapping is not unique, the UE 304 can perform blind decoding for all possible location of PDSCH carrying message 2.

Pursuant to a further example, UE 304 can transmit the scheduled transmission (message 3) generated by identity conveyance component 308 to base station 302 without decoding downlink acknowledging channels (e.g., PHICH, . . . ). UE 304 can send a fixed amount of transmissions or retransmissions to base station 302 when sending message 3 without decoding PHICH in downlink. The number of times the retransmission to base station 302 can be preselected or dynamically changed.

According to another example, the contention resolution message (message 4) yielded by contention resolution component 312 can be transmitted by base station 302 to UE 304, and UE 304 can decode a data channel carrying the contention resolution message without decoding control channels. The location of the data channel containing contention resolution message can be linked to temp-RNTI, sub-frame number, system frame number and/or UE ID or other information know to UE and base station after processing message 3. The UE 304 can also blind decode different location and/or different MCS.

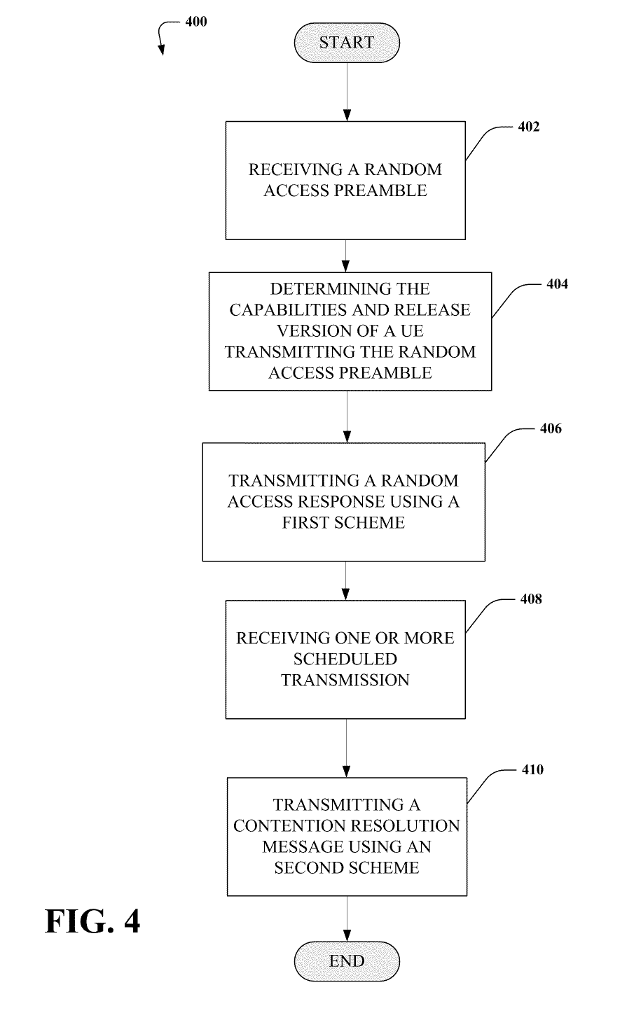

Referring to FIGS. 4-11, methodologies relating to enhancements to random access procedures used in a wireless communication environment described in the above examples are illustrated. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

With reference to FIG. 4, illustrated is methodology 400 used by the base station 302 during the enhanced procedure. At 402, Message 1 (random access preamble) is received by the base station 302 from a user equipment (e.g., UE 304) that is requesting access to communication resources. At 404, upon receipt of Message 1, the base station can determine, by decoding the Message 1, the capabilities and the release versions (e.g., Rel-8, Rel-9, Rel-10, etc.) of the transmitting UE. In an aspect, the base station reserves a set of RACH sequences based on release versions, such that RACH sequences are applicable to Rel-9 and beyond UEs. The UE 304 can provide one or more RACH sequences within the Message 1. Using the received RACH sequence received with Message 1, this method can determine the version and capabilities of the UE. At 406, the base station can transmit Message 2 (a random access sequence response) using a first scheme. The first scheme comprise transmitting one or more RACH sequences and how the sequences should be used using system information block (SIB), through Physical Broadcast Channel (PBCH), a Primary Synchronization Signal (PSS), a Secondary Synchronization Signal (SSS), Primary Reference Signal (PRS), Reference Signal (RS), and the like. According to another example, the first scheme comprises and indication (e.g. a flag) to indicate whether there exists sets of RACH sequences reserved for utilization by the given release of UEs exists. Following this example, the flag can be in SIB, PBCH, PSS, SSS, PRS, RS, and/or a combination thereof. According to another example, the base station can provide additional information, such as temp-RNTI or uplink grant, using payload portion of the Message 2 and/or using preamble portion of the RACH sequence. The resources and/or modulation and coding scheme (MCS) used for transmitting Message 2 can be linked to information already known to UE 304 (such as random access-RNTI, Cell ID, sub-frame number, system frame number and Tx antenna information or any other information UE has acquired through downlink channels).

At 408, base station 302 monitors for a Message 3 (scheduled transmission). The base station 302 may received a fixed number of Message 3 from UE 304 as part of HARQ mechanism of a UE 304. If the base station 302 is able to decode Message 3 successfully, the base station ignores repeated Message 3s. At 410, the base station 302 can transmits Message 4 (contention resolution message) to complete the enhanced procedure using a second scheme. The second scheme comprises a transmission of payload portion of Message 4 without using control channels. The payload portion of the Message 4 can be transmitted using frequency allocated to a data portion and not control portion. The data portion comprises a set of channels allocated to transmit data and the control portion comprises as set of channels allocated to transmit control information. The location in frequency of payload portion can be linked to temp-RNTI, sub-frame number, system frame number, UE ID, and/or other information.

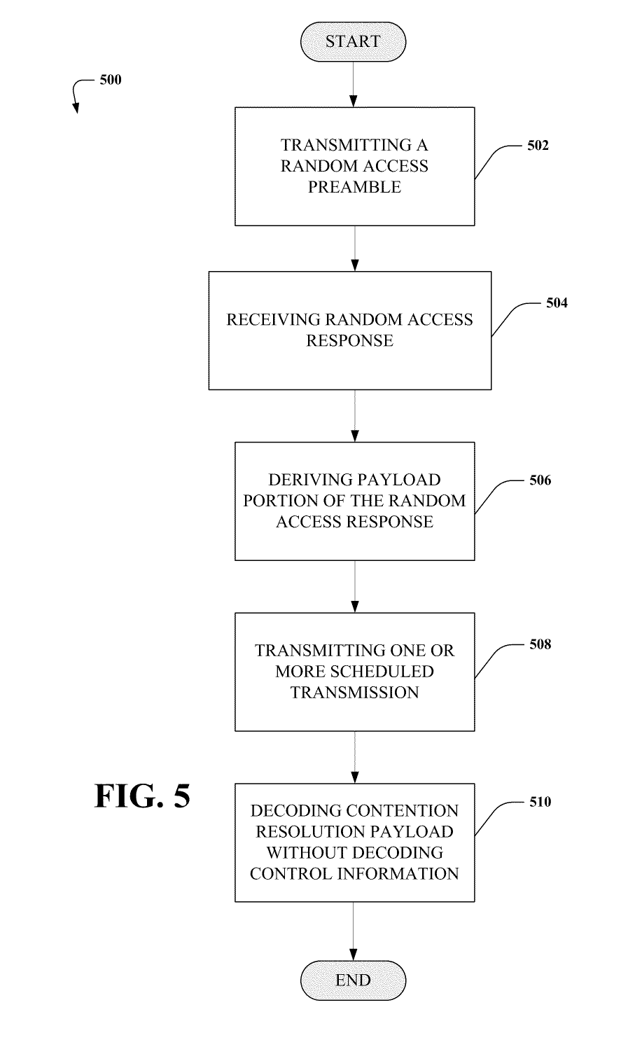

With reference to FIG. 5, illustrated is methodology 500 used by the user equipment (UE) 304 during an enhanced procedure. At 402, Message 1 (random access preamble) is transmitted to the base station 302. If the UE 304 has Rel-9, Rel-10, or beyond version, then an appropriate RACH sequence is used to provide the release version to base station 302. The UE 304 can began monitoring for reception of random access response from base station. At 504, the UE receives random access response from base station. As an example, the UE need not decode the control channel in order to receive the information. According to an aspect, the UE can derive payload portion of the random access response in several ways. In an aspect, the UE can decode the payload of Message 2 without having to decode the entire Message 2. The UE can decode, SIB, PBCH, PSS, SSS, PRS, RS, and/or a combination thereof, to derive a RACH sequence. Using the preamble of the RACH sequence and other known information (such as random access-RNTI, Cell ID, sub-frame number, system frame number and Tx antenna information or any other information UE has acquired through downlink channels), the UE derives Message 2 payload information (such as temp-RNTI and uplink grant) without having to decode Message 2. The UE can also derive the resources and/or modulation and coding scheme (MCS) used for transmitting Message 2 which are linked to information already known to UE 304 (such as random access-RNTI, Cell ID, sub-frame number, system frame number and Tx antenna information or any other information UE has acquired through downlink channels). If the resource mapping is not unique, the UE can perform blind decoding of all possible locations of PDSCH carrying Message 2.

At 508, the UE can transmit a number of transmission and retransmission to base station 302 for sending Message 3 (scheduled transmission). The number of transmission can be predetermined or dynamically adjusted based on communication environment. At 510, the method decodes Message 4 (contention resolution message) payload without having to decode control information. In order to decode Message 4 (contention resolution message) the UE can decode a predefine location within a range of frequency, wherein the location and/or a modulation and coding scheme (MCS) used are linked to the temp-RNTI, sub-frame number, system frame number, UE ID, and/or other information known to UE and base station. Using the temp-RNTI, sub-frame number, system frame number, UE ID, and/or other information the UE can decode the Message 4 without having to decode the control channels. The UE can also, perform a blind decoding of a range of frequency allocated as data region to decode Message 4. Thus, UE 304 need not decode the region allocated for transmission of control information for decoding Message 4.

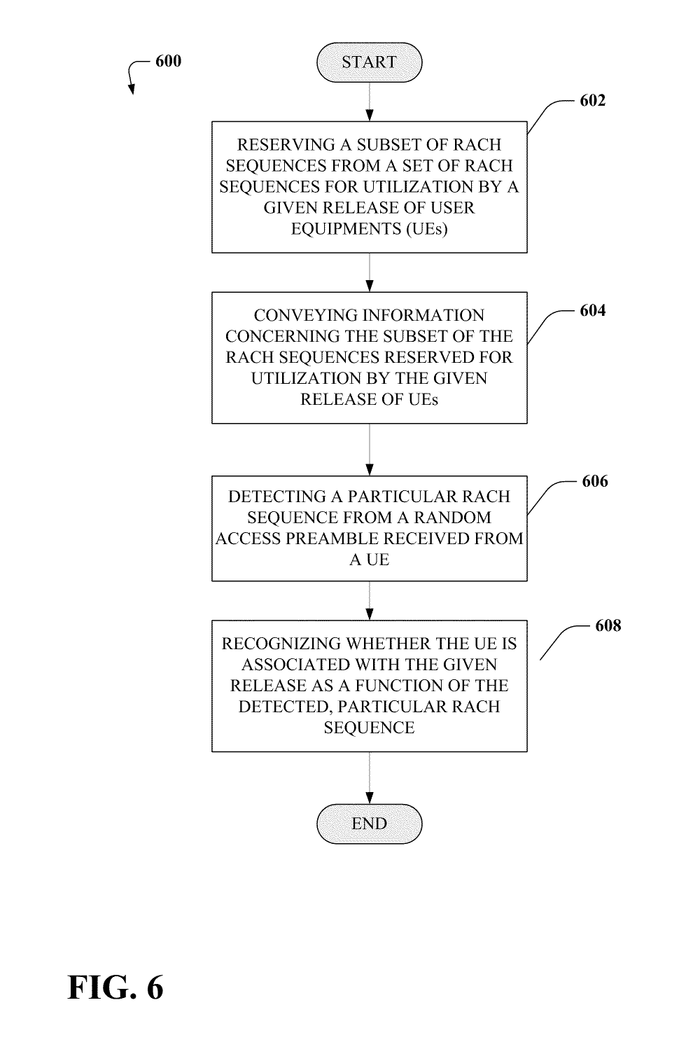

With reference to FIG. 6, illustrated is a methodology 600 that facilitates allowing different releases of UEs to use different subsets of Random Access Channel (RACH) sequences for delivering a random access preamble (message 1) in a wireless communication environment. At 602, a subset of RACH sequences from a set of RACH sequences can be reserved for utilization by a given release of User Equipments (UEs). Thus, a base station can reserve the subset of RACH sequences for use by Rel-9 and beyond UEs; however, it is also contemplated that the subset of RACH sequences can alternatively be reserved for use by Rel-8 UEs, Rel-10 and beyond UEs, and so forth. At 604, information concerning the subset of the RACH sequences reserved for utilization by the given release of UEs can be conveyed. For instance, the information concerning the reserved subset of the RACH sequences and usage related thereto can be conveyed by the base station through a system information block. Additionally or alternatively, the base station can convey the aforementioned information through a Physical Broadcast Channel (PBCH). For instance, a portion of a payload associated with PBCH can be used to indicate that a certain subset (e.g., reserved subset, . . . ) of RACH sequences is for Rel-9 and beyond UEs. By way of another illustration, the foregoing information can be conveyed by the base station through one or more physical signals such as, for instance, a Primary Synchronization Signal (PSS), a Secondary Synchronization Signal (SSS), Primary Reference Signal (PRS), Reference Signal (RS), and the like. According to another example, the base station can signal a flag to indicate whether the subset of RACH sequences reserved for utilization by the given release of UEs exists. Following this example, the flag can be in a system information block (SIB), PBCH, PSS, SSS, PRS, RS, and/or a combination thereof. At 606, a particular RACH sequence can be detected from a random access preamble received from a UE. The particular RACH sequence can be detected by decoding the random access preamble (message 1). At 608, recognition as to whether the UE is associated with the given release can be effectuated as a function of the detected, particular RACH sequence. Thus, the base station can know that the UE is a Rel-8 UE or a Rel-9 and beyond UE based upon the detected, particular RACH sequence. Hence, UE capability information can be delivered to enable differentiating Rel-8 UEs from Rel-9 and beyond UEs, which can be beneficial since Rel-9 and beyond UEs can support the base station applying enhanced procedures, while Rel-8 RACH procedures can be applied by the base station for Rel-8 UEs.

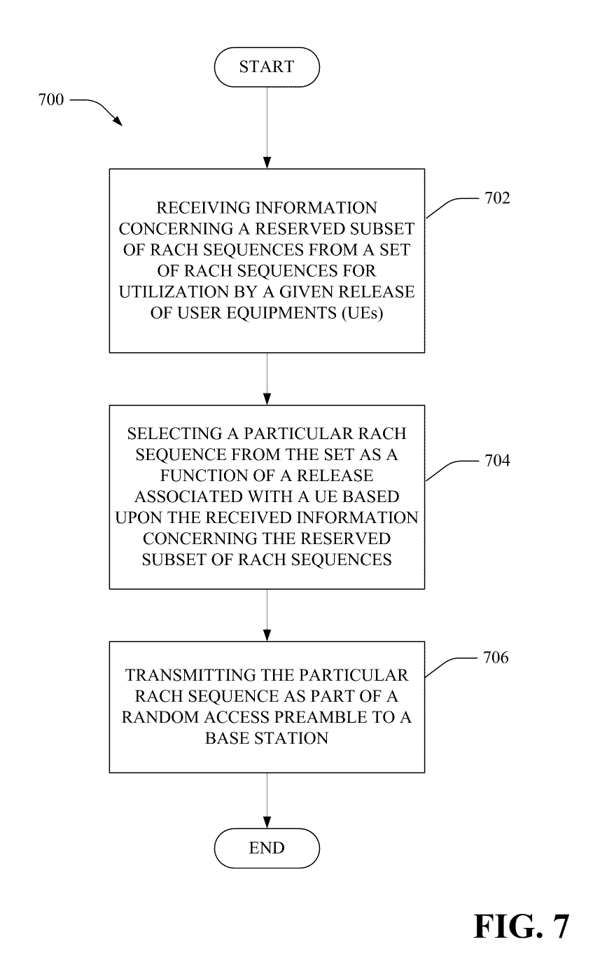

Turning to FIG. 7, illustrated is a methodology 700 that facilitates delivering UE capability information to a base station in a wireless communication environment. At 702, information concerning a reserved subset of RACH sequences from a set of RACH sequences for utilization by a given release of User Equipments (UEs) can be received. For instance, the subset of RACH sequences can be reserved for use by Rel-9 and beyond UEs; however, the claimed subject matter is not so limited. Moreover, the information can be received through a system information block, PBCH, and/or physical signal (e.g., PSS, SSS, PRS, RS, . . . ). Further, a flag can be obtained that indicates whether the reserved subset of RACH sequences exists; the flag can be in SIB, PBCH, PSS, SSS, PRS, RS, or a combination thereof. At 704, a particular RACH sequence from the set can be selected as a function of a release associated with a UE based upon the received information concerning the reserved subset of RACH sequences. For example, a Rel-9 UE can select a reserved RACH sequence from the reserved subset of RACH sequences, while a Rel-8 UE can select a non-reserved RACH sequence not included in the reserved subset of RACH sequences. According to another example, a Rel-9 UE can choose to not use the RACH sequences from the reserved subset to indicate to a base station that such UE still uses the Rel-8 RACH procedure. At 706, the particular RACH sequence can be transmitted as part of a random access preamble to a base station.

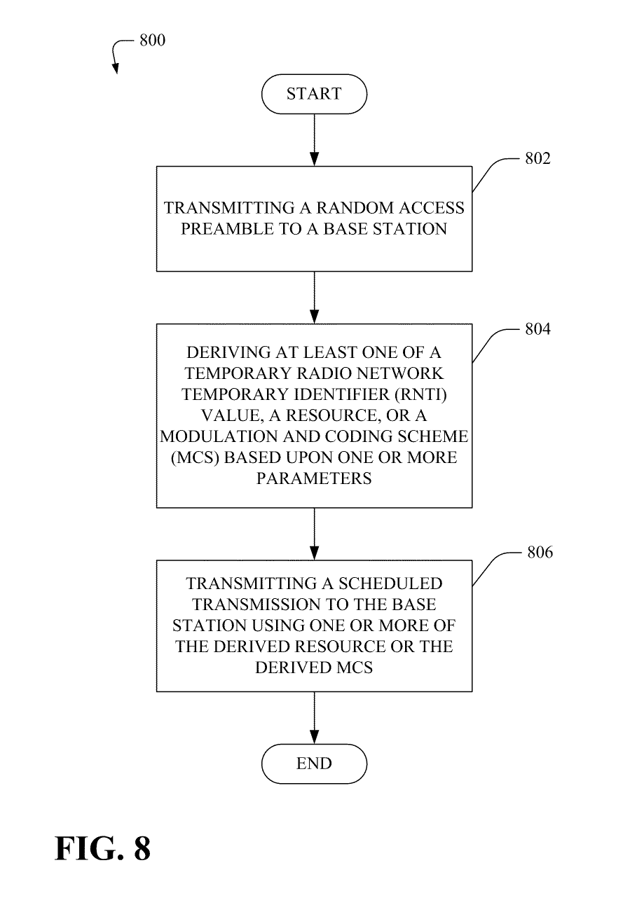

Referring to FIG. 8, illustrated is a methodology 800 that facilitates delivering a temporary radio network temporary identifier (RNTI) and/or a grant to a UE without using a random access response (message 2) in a wireless communication environment. At 802, a random access preamble can be transmitted to a base station. In response to the random access preamble (message 1), a random access response need not be obtained from the base station (e.g., the base station can choose not to send the random access response and/or not to transmit a temporary RNTI to the UE through the random access response, . . . ). At 804, at least one of a temporary radio network temporary identifier (RNTI) value, a resource, or a modulation and coding scheme (MCS) can be derived based upon one or more parameters. The temporary RNTI value can be linked to a preamble sequence, a random access RNTI (RA-RNTI), a Cell ID, a subframe number, system frame number, transmit (Tx) antenna information, or any other information a UE has acquired through downlink channels. Thus, the UE can derive the temporary RNTI value by using one or more of the aforementioned parameters. Similarly, the resource and/or MCS used for a scheduled transmission (message 3) or other information typically carried in a conventional random access response (message 2) can be derived using one or more of the aforementioned parameters. It is contemplated that the mapping function can be the same or different for the resource, MCS, or other information as compared to the mapping for the temporary RNTI value. At 806, a scheduled transmission (message 3) can be transmitted to the base station using one or more of the derived resource or the derived MCS.

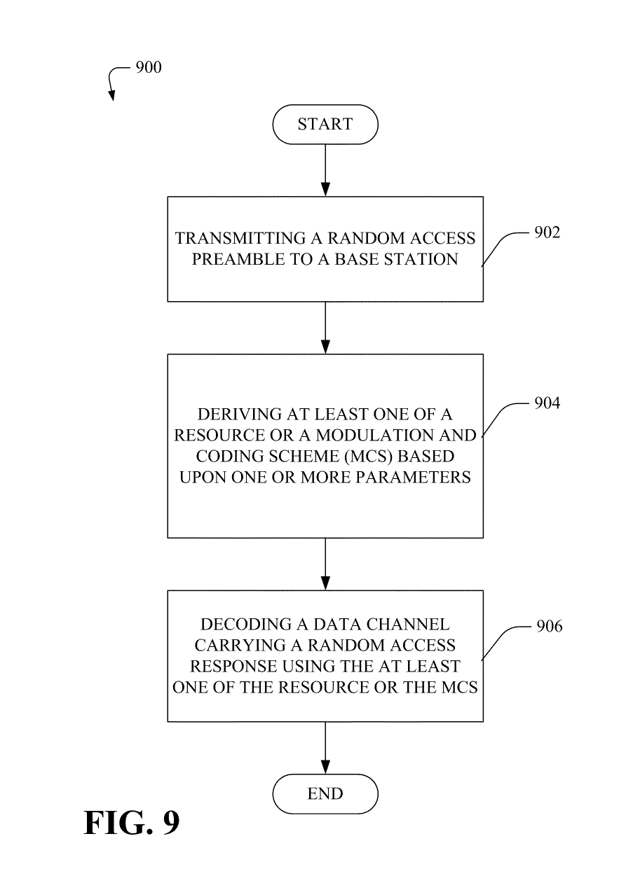

Turning to FIG. 9, illustrated is a methodology 900 that facilitates decoding a data channel that carried a random access response (message 2) without decoding control channels in a wireless communication environment. At 902, a random access preamble can be transmitted to a base station. At 904, at least one of a resource or a modulation and coding scheme (MCS) can be derived based upon one or more parameters. The resource and/or the MCS can be used by the base station for sending a random access response (message 2). Further, the one or more parameters can include preamble sequence, RA-RNTI, Cell ID, system subframe number, Tx antenna information, or any other information a UE has acquired through downlink channels. Further, the one or more parameters can be linked to the resource and/or MCS used by the base station. Hence, the UE can derive the resource and/or MCS (or other information) used for decoding a data channel (e.g., Physical Downlink Shared Channel (PDSCH), . . . ) through a mapping function without decoding control channels. At 906, a data channel carrying a random access response (message 2) can be decoded using the at least one of the resource or the MCS. The data channel can be the PDSCH, for instance. Further, if the resource mapping is not unique, the UE can perform blind decoding of possible locations of PDSCH carrying message 2.

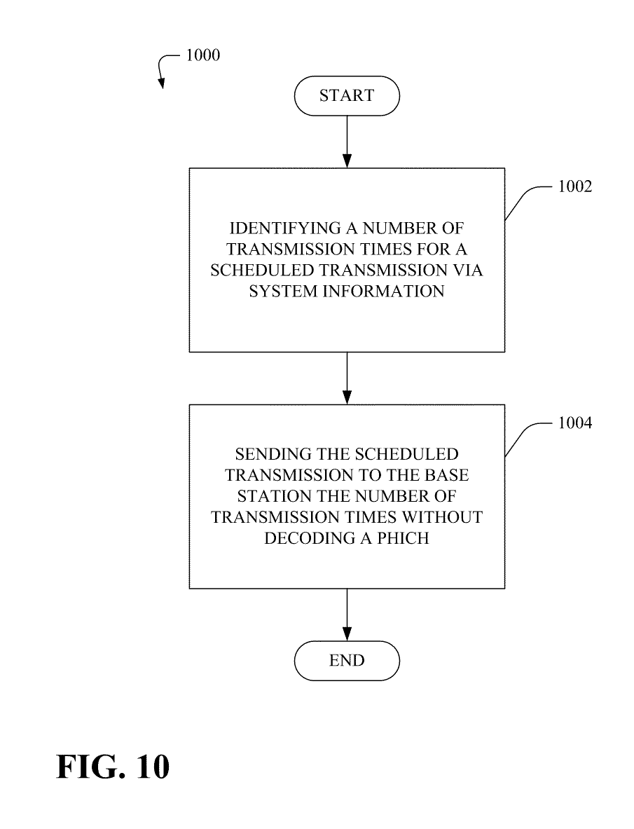

With reference to FIG. 10, illustrated is a methodology 1000 that facilitates sending a scheduled transmission (message 3) without decoding downlink acknowledging channels in a wireless communication environment. At 1002, a number of transmission (or retransmission) times for a scheduled transmission can be identified via system information. Thus, the number of transmission or retransmission times can be delivered in system information. At 1004, the scheduled transmission to the base station can be sent the number of transmission times without decoding a PHICH. Rather, a fixed amount of transmissions or retransmissions to the base station can be transmitted when sending message 3.

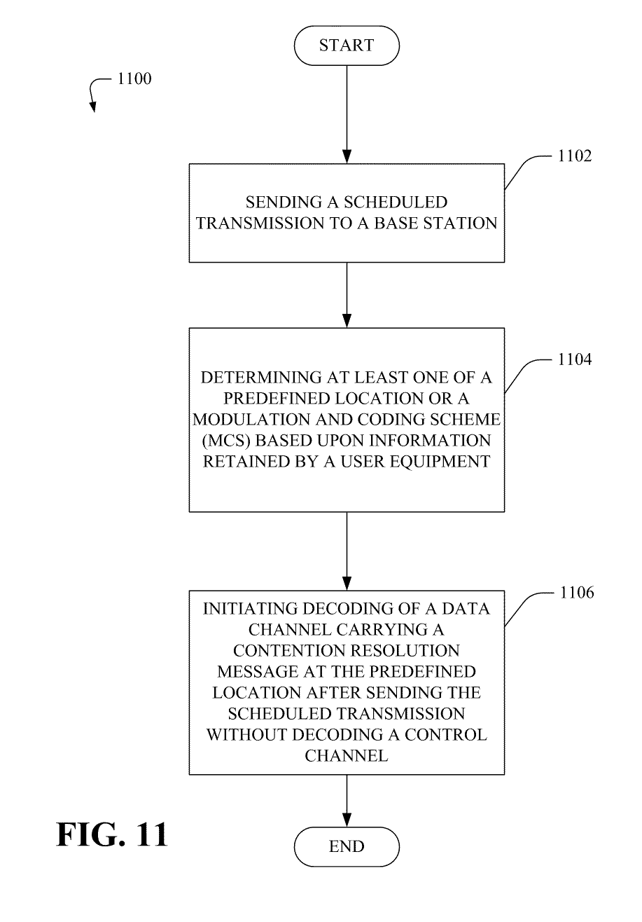

Turning to FIG. 11, illustrated is a methodology 1100 that facilitates decoding a contention resolution message (message 4) without decoding control channels in a wireless communication environment. At 1102, a scheduled transmission can be sent to a base station. At 1104, at least one of a predefined location or a modulation and coding scheme (MCS) can be determined based upon information retained by a User Equipment (UE). The predefined location and/or MCS can be linked to a temporary RNTI, subframe number, system frame number, and/or UE ID (or other information known to the UE and base station at such stage). Moreover, the predefined location need not be unique; for instance, the UE can perform blind decoding at different locations and/or different MCSs. At 1106, decoding of a data channel carrying a contention resolution message (message 4) can be initiated at the predefined location after sending the scheduled transmission without decoding a control channel.

It is to be understood that the aspects described herein may be implemented by hardware, software, firmware or any combination thereof. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. An apparatus operable in a wireless communication system, the apparatus comprising:
means for transmitting a random access preamble, wherein the random access preamble comprises release version information of user equipment;
means for deriving a payload portion of a random access response; and
means for receiving a contention resolution message.

2. The apparatus of claim 1, wherein the means for transmitting the random access preamble comprises means for transmitting one or more random access channel (RACH) sequences associated with release version of user equipment.

3. The apparatus of claim 1, wherein the means for transmitting the random access preamble comprises means for indicating all capabilities of user equipment.

4. The apparatus of claim 1, wherein the means for deriving a payload portion of the random access response comprises means for using a RACH sequence.

5. The apparatus of claim 4, wherein the means for deriving a payload portion of the random access response comprises means for using a preamble of the RACH sequence.

6. The apparatus of claim 1, wherein the means for deriving a payload portion of the random access response comprises means for decoding temp-RNTI using a preamble of a RACH sequence.

7. The apparatus of claim 1, wherein the means for deriving a payload portion of the random access response comprises means for using a blind decoding scheme

8. The apparatus of claim 1, wherein the means for receiving a contention resolution message comprises means for decoding a portion of frequency used for transmission of data.

9. The apparatus of claim 1, further comprising:
means for decoding a payload portion of the contention resolution message using a temp-radio network temporary identifier.

10. The apparatus of claim 1, further comprising:
means for decoding a payload portion of the contention resolution message using at least a sub-frame number, system frame number, user equipment identification, or temp-radio network temporary identifier (temp-RNTI).

11. The apparatus of claim 1, further comprising:
means for deriving a payload portion of the contention response message using a blind decoding scheme.

12. The apparatus of claim 1, further comprising:
means for deriving modulation and coding scheme (MSC) used for the random access response by a transmitting entity.

13. The apparatus of claim 12, wherein the means for deriving the MCS comprises means for using at least a sub-frame number, system frame number, user equipment identification, or temp-radio network temporary identifier (temp-RNTI).

14. The apparatus of claim 1, further comprising means for receiving a random access response.

15. The apparatus of claim 1, further comprising means for deriving a Random Access Channel (RACH) sequence.

16. The apparatus of claim 1, further comprising means for transmitting one or more scheduled transmission.

17. An apparatus operable in a wireless communication system, the apparatus comprising:
means for receiving a random access preamble;
means for determining a release version of user equipment transmitting the random access preamble;
means for selecting one or more Random Access Channel (RACH) sequences from a set of RACH sequences based on release version of user equipment transmitting the random access preamble to generate a random access response; and
means for transmitting the random access response using a first scheme.

18. The apparatus of claim 17, further comprising means for determining capabilities of user equipment transmitting the random access preamble.

19. The apparatus of claim 17, wherein the means for transmitting the random access response comprises means for transmitting an indication to indicate whether the random access response includes at least one RACH sequence associated with the release version of user equipment transmitting the random access preamble.

20. The apparatus of claim 19, wherein the means for using the first scheme comprises means for using at least one of system information block (SIB), through Physical Broadcast Channel (PBCH), a Primary Synchronization Signal (PSS), a Secondary Synchronization Signal (SSS), Primary Reference Signal (PRS) or Reference Signal (RS) to transmit the indication.

21. The apparatus of claim 17, wherein the means for transmitting the random access response comprises means for including, as part of the random access response, a RACH sequence associated with a release version of user equipment transmitting the random access preamble.

22. The apparatus of claim 21, wherein the means for using the first scheme comprises means for using at least one of system information block (SIB), through Physical Broadcast Channel (PBCH), a Primary Synchronization Signal (PSS), a Secondary Synchronization Signal (SSS), Primary Reference Signal (PRS), or Reference Signal (RS) to transmit the RACH sequence.

23. The apparatus of claim 17, further comprising:
means for receiving and decoding one or more scheduled transmission, and ignoring any scheduled transmission received after successful decoding of at least one of the received scheduled transmission.

24. The apparatus of claim 17, further comprising means for transmitting a contention resolution message using a second scheme.

25. The apparatus of claim 24, wherein the means for using the second scheme comprises means for using a portion of frequency allocated to transmitting data.

26. The apparatus of claim 24, wherein the means for using second scheme comprises means for linking the location of frequency to at least a sub-frame number, system frame number, user equipment identification, or temp-radio network temporary identifier (temp-RNTI).

27. A method for a wireless communication system, the apparatus comprising:
transmitting a random access preamble, wherein the random access preamble comprises release version information of user equipment;
deriving a payload portion of a random access response; and
receiving a contention resolution message.

28. The method of claim 27, wherein transmitting the random access preamble comprises transmitting one or more random access channel (RACH) sequences associated with release version of user equipment.

29. The method of claim 27, wherein transmitting the random access preamble comprises indicating all capabilities of user equipment.

30. The method of claim 27, wherein deriving payload portion of the random access response comprises using a RACH sequence.

31. The method of claim 30, wherein deriving payload portion of the random access response comprises using a preamble of the RACH sequence.

32. The method of claim 27, wherein deriving payload portion of the random access response comprises decoding temp-RNTI using a preamble of a RACH sequence.

33. The method of claim 27, wherein deriving payload portion of the random access response comprises using a blind decoding scheme

34. The method of claim 27, wherein receiving the contention resolution message comprises decoding a portion of frequency used for transmission of data.

35. The method of claim 27, further comprising:
decoding a payload portion of the contention resolution message using a temp-radio network temporary identifier.

36. The method of claim 27, further comprising:
decoding a payload portion of the contention resolution message using at least a sub-frame number, system frame number, user equipment identification, or temp-radio network temporary identifier (temp-RNTI).

37. The method of claim 27, further comprising:
deriving payload portion of the contention response message using a blind decoding scheme.

38. The method of claim 27, further comprising:
deriving modulation and coding scheme (MSC) used for the random access response by a transmitting entity.

39. The method of claim 38, wherein deriving the MCS comprises using at least a sub-frame number, system frame number, user equipment identification, or temp-radio network temporary identifier (temp-RNTI).

40. The method of claim 27, further comprising receiving a random access response.

41. The method of claim 27, further comprising deriving a Random Access Channel (RACH) sequence.

42. The method of claim 27, further comprising transmitting one or more scheduled transmission.

43. A method for a wireless communication system, the apparatus comprising:
receiving a random access preamble;
determining a release version of user equipment transmitting the random access preamble;
selecting one or more Random Access Channel (RACH) sequences from a set of RACH sequences based on the release version of a user equipment transmitting the random access preamble to generate a random access response; and
transmitting the random access response using a first scheme.

44. The method of claim 43, further comprising determining capabilities of user equipment comprises means for transmitting the random access preamble.

45. The method of claim 43, wherein transmitting the random access response comprises transmitting an indication to indicate whether the random access response contains the RACH sequence associated with the release version of user equipment transmitting the random access preamble.

46. The method of claim 45, wherein using the first scheme comprises using at least one of system information block (SIB), through Physical Broadcast Channel (PBCH), a Primary Synchronization Signal (PSS), a Secondary Synchronization Signal (SSS), Primary Reference Signal (PRS) or Reference Signal (RS) to transmit the indication.

47. The method of claim 43, wherein transmitting the random access response comprises including, as part of the random access response, the RACH sequence associated with the release version of user equipment transmitting the random access preamble.

48. The method of claim 47, wherein using the first scheme comprises using at least one of system information block (SIB), through Physical Broadcast Channel (PBCH), a Primary Synchronization Signal (PSS), a Secondary Synchronization Signal (SSS), Primary Reference Signal (PRS) or Reference Signal (RS) to transmit the RACH sequence.

49. The method of claim 43, further comprising:
receiving and decoding one or more scheduled transmission, and ignoring any scheduled transmission received after successful decoding of at least one the received scheduled transmission.

50. The method of claim 43, further comprising transmitting a contention resolution message using a second scheme.

51. The method of claim 50, wherein using second scheme comprises using portion of frequency allocated to transmitting data.

52. The method of claim 50, wherein using second scheme comprises linking the location of frequency to at least a sub-frame number, system frame number, user equipment identification, or temp-radio network temporary identifier (temp-RNTI).

53. A computer program product, comprising:
a computer-readable medium comprising:
code for transmitting a random access preamble, wherein the random access preamble comprises release version information of user equipment;
code for deriving a payload portion of a random access response; and
code for receiving a contention resolution message.

54. A computer program product, comprising:
a computer-readable medium comprising:
code for receiving a random access preamble;
code for determining a release version of user equipment transmitting the random access preamble;
code for selecting one or more Random Access Channel (RACH) sequences from a set of RACH sequences based on the release version of a user equipment transmitting the random access preamble to generate a random access response; and
code for transmitting the random access response using a first scheme.

55. A wireless communications apparatus, comprising:
a processor configured to:
transmit a random access preamble, wherein the random access preamble comprises release version information of user equipment;
derive a payload portion of a random access response; and
receive a contention resolution message.

56. A wireless communications apparatus, comprising:
a processor configured to:
receive a random access preamble;
determine a release version of user equipment transmitting the random access preamble;
select one or more Random Access Channel (RACH) sequences from a set of RACH sequences based on the release version of a user equipment transmitting the random access preamble to generate a random access response; and
transmit the random access response using a first scheme.
